(19) United States
(12) Patent Application Publication
(10) Pub. No.: US 2013/0088021 A1
(43) Pub. Date: Apr. 11, 2013

(54) Vehicle Door Mechanism

(71) Applicants: Gary W. Krajenke, Warren, MI (US); Alvin N. Standard, Clarkston, MI (US); Daniel S. Albert, Romeo, MI (US)

(72) Inventors: Gary W. Krajenke, Warren, MI (US); Alvin N. Standard, Clarkston, MI (US); Daniel S. Albert, Romeo, MI (US)

(73) Assignee: GM GLOBAL TECHNOLOGY OPERATIONS LLC, DETROIT, MI (US)

(21) Appl. No.: 13/267,190

(22) Filed: Oct. 6, 2011

(51) Int. Cl. E05C 3/14; E05C 3/12

(52) U.S. Cl. 292/217; 292/213

(57) ABSTRACT

A mechanism for controlling a vehicle door includes upper and lower striker pins secured to a door opening, an upper latch assembly pivotably connectable to the door, including inboard and outboard latches, and a slotted hole extending between the latches and into which the upper striker pin is fitted, and a lower latch assembly pivotably connectable to the door, including inboard and outboard latches, a second slotted hole extending between the latches and into which the lower striker pin is fitted, and a second hinge pin secured to the lower latch assembly.

### BACKGROUND OF INVENTION

The present invention relates generally to an apparatus for opening and closing the doors of a vehicle, particularly the rear cargo doors of a van.

The rear cargo doors of a van conventionally open by rotating on their hinges 180 degrees to a fully open position, allowing unobstructed access to the interior compartment. When the doors are in the 180 degree open position they extend laterally further than the widest part of the vehicle, potentially interfering with other vehicles and pedestrian traffic.

A need exists in the industry for the open rear cargo doors to be located parallel and close the sides of the vehicle. A mechanism is desired that permits the door hinge pivot points to move outboard enough to allow the door to rotate further than through an angle of 180 degrees, preferably to about 360 degrees.

### SUMMARY OF INVENTION

A mechanism for controlling a vehicle door includes upper and lower striker pins secured to a door opening, an upper latch assembly pivotably connectable to the door, including inboard and outboard latches, and a slotted hole extending between the latches and into which the upper striker pin is fitted, and a lower latch assembly pivotably connectable to the door, including inboard and outboard latches, a second slotted hole extending between the latches and into which the lower striker pin is fitted, and a second hinge pin secured to the lower latch assembly.

The mechanism allows the doors to pivot open more than the conventional 180 degrees such that the doors pivot around the side of the vehicle allowing added clearance for other vehicles and pedestrians. The door has releasing and engaging latches that allow the door to pivot to an extended position in order to change the location of the hinge pivot point, thereby allowing for the additional rotation of the door.

The latches control the sequence for pivoting the door to either its normal or additional extended positions. These latches would be controlled by release handles located nearest the ends of the door furthest from the vehicle. The mechanism has curved slots, which provide smooth motion while repositioning of the doors.

The inboard and outboard latches are self-engaging such that upon being delatched and the door pivoted to the required position, the latches automatically relatch.

To accommodate the multi-positioning of the door, a retractable stop strap limits pivoting of the door until the strap is released to extend further allowing the door to extend to the fully opened position.

This invention will allow more utility usage of vehicle by both commercial and non-commercial customers thus enhancing the marketing prospects of the current cargo van.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### BRIEF DESCRIPTION OF DRAWINGS

FIGS. 1A-1C show progressive movement of a left rear cargo door when supported on latching mechanisms;

FIG. 2 is a front view of the upper latch mechanism shown in FIG. 1;

FIG. 3 is a front view of the upper latch mechanism showing inboard and outboard latches at the extremities of the slotted hole;

FIG. 4 is a perspective view showing the door having been pivoted outward and limited by a stop strap; and

FIG. 5 is a top view showing the door in its fully opened position.

### DETAILED DESCRIPTION

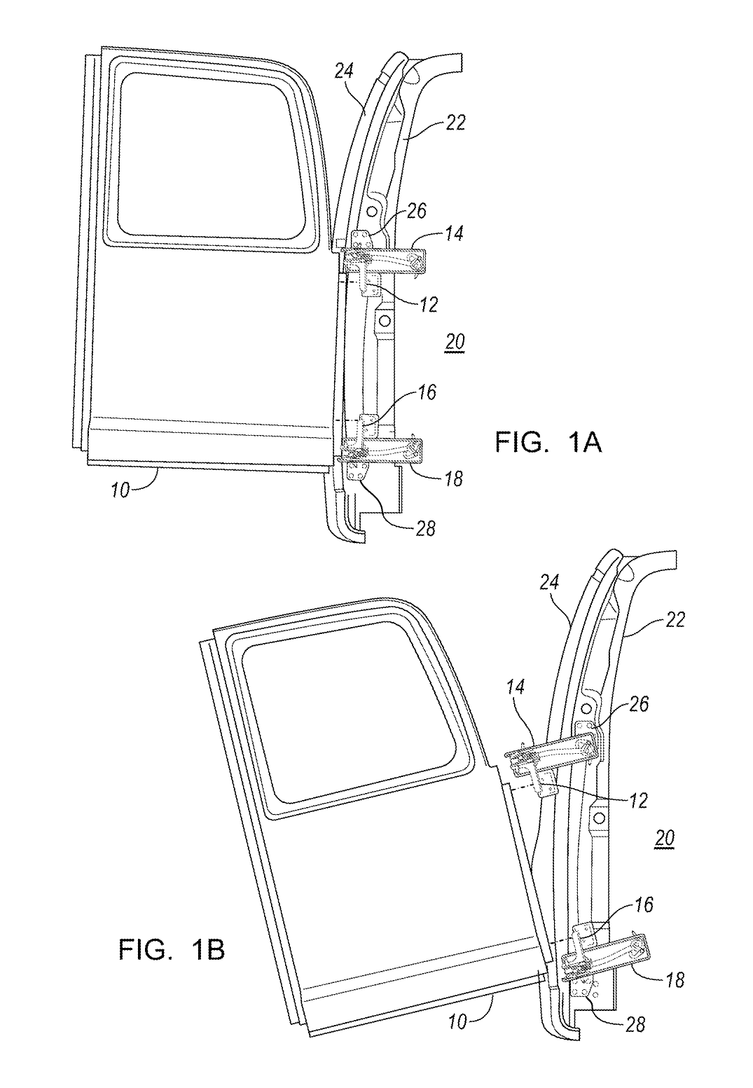

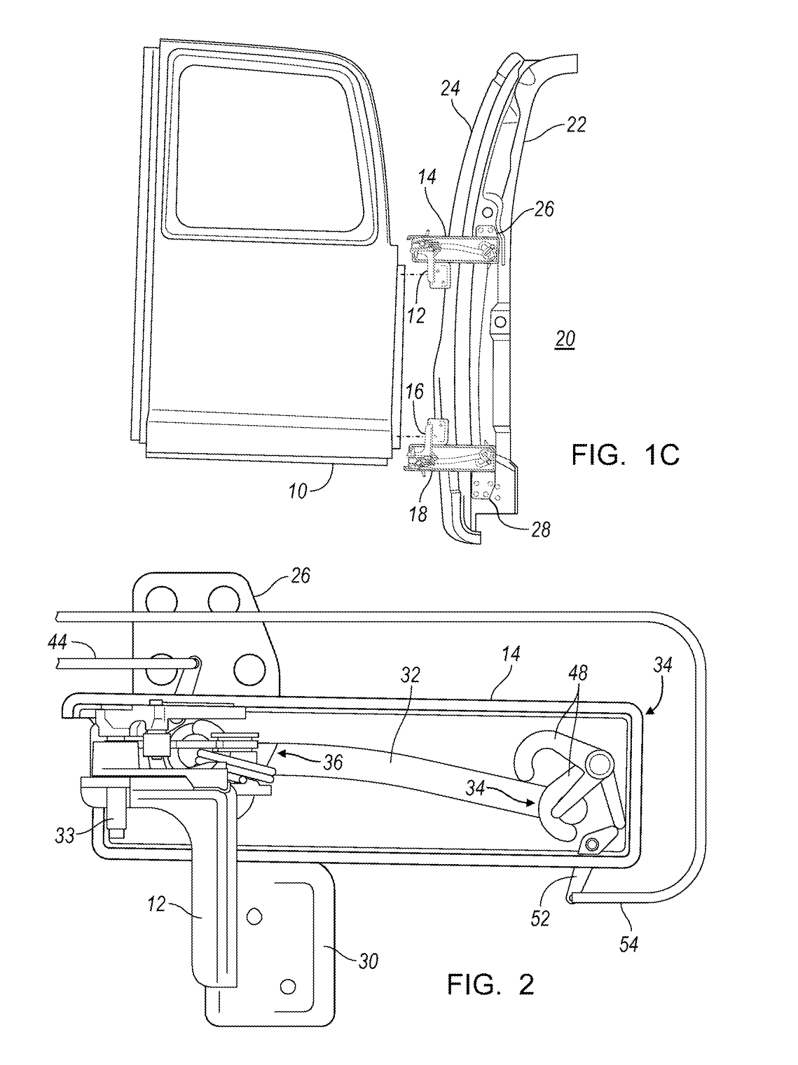

Referring now to the drawings, FIG. 1A shows a left rear cargo door 10 having been opened by pivoting on its hinges through an angle of about 180 degrees. The door 10 is supported on an upper hinge bracket 12, which is secured to the door and to an upper latch assembly 14. The door is supported also on a lower hinge bracket 16, which is secured to the door and to a lower latch assembly 18. The door opening 20 is enclosed by a frame 22, which supports the left body side panel 24. The upper and lower latch assemblies 14, 18 are secured to the frame 22 by bolted connections to upper and lower straps 26, 28, which are secured to brackets 12, 16, respectively.

FIG. 1B shows the upper latch assembly 14 having been delatched and relatched at another lateral position on latch assembly 14 such that the door 10 pivots downward or counterclockwise while being supported on the frame 22 by the upper and lower latch assemblies 14, 18. Both the upper and lower latch assemblies 14, 18 have pivoted counterclockwise, but only the upper latch assembly 14 has been displaced outboard from the position shown in FIG. 1A.

FIG. 1C shows the lower latch assembly 18 having been delatched and relatched at another lateral position on latch assembly 18 such that the door 10 can be lifted upward or clockwise while being supported on the frame 22 by the upper and lower latch assemblies 14, 18. Both the upper and lower latch assemblies 14, 18 have pivoted clockwise, but only the lower latch assembly 18 has been displaced outboard from the position shown in FIG. 1B.

The door 10 is continually supported on frame 22 due to its being secured to brackets 12, 16, which are pivotally supported on the upper and lower latch assemblies 14, 18. The door 10 is then pivoted further on its hinges through an angle of about 180 degrees to the position shown in FIG. 5.

Referring to FIG. 2, the upper hinge bracket 12 is welded to a strap 30, which is bolted to a surface of the door 10 (shown in FIG. 1A), the hinge bracket 12 being bolted to another surface of the door substantially normal to the surface of strap 30. The upper hinge pin 33 is fixed to upper hinge bracket 12 providing a pivot about which door 10 swings.

The upper and lower latch assemblies 14, 18 are each formed with an arcuate slotted hole 32, which extends laterally between an inboard latch 34 and an outboard latch 36. The arcuate slotted hole 32 of the upper latch assembly 14 has its center located below the hole. The arcuate slotted hole of the hole of the lower latch assembly 18 has its center located above the hole.

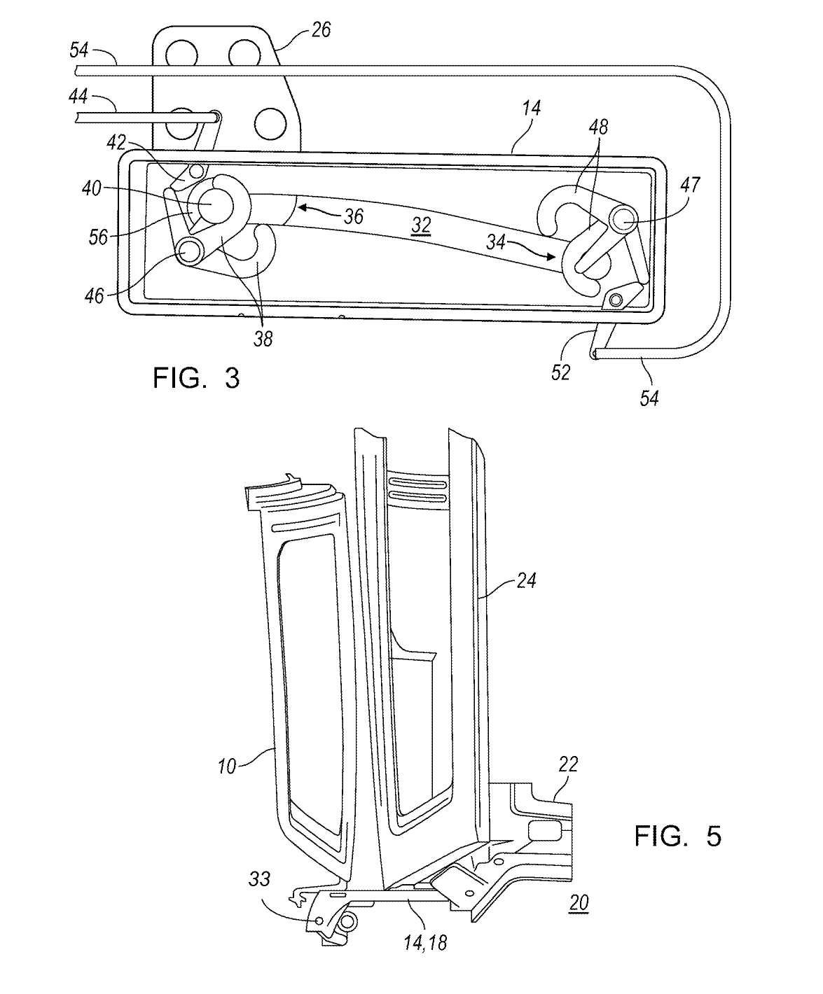

As FIGS. 2 and 3 show, the outboard latch 36 of the upper latch assembly 14 comprises a pivoting fork bolt 38 (shown in two different positions in FIG. 3); a striker pin 40 secured to upper strap 26; a detent lever 42 for holding fork bolt 38 latched to the striker pin 40; an actuator 44 such as a cable that controls the latched and delatched state of the striker pin 40 produced by the fork bolt 38; and a torsion spring (not shown) centered at pivot pin 46 for biasing the fork bolt 38 to disengage the striker pin 40 when the detent lever 42 pivots counterclockwise when tension is applied by the actuator 44.

Similarly, the inboard latch 34 of the upper latch assembly 14 comprises a pivoting fork bolt 48 (shown in two different positions in FIGS. 2 and 3); a striker pin 40 secured to lower strap 26; a detent lever 52 for holding fork bolt 48 latched to the striker pin 40; an actuator 54 such as a cable that controls the latched and delatched state of the striker pin 40 produced by the fork bolt 48; and a torsion spring (not shown) centered at pivot pin 47 for biasing the fork bolt 48 to disengage the striker pin 40 when the detent lever 52 pivots counterclockwise when tension is applied by the actuator 54.

Each striker pin 40 is formed with a circular flange 56, which overlaps the upper and lower surfaces of each slotted hole 32 as movement of the door 10 causes displacement of the upper and lower latch assemblies 14, 18 relative to their respective striker pins 40.

The lower latch assembly 18, lower strap 28 and lower hinge bracket 16 are arranged, connected and supported as described with respect to the upper latch assembly 14, upper strap 26 and upper hinge bracket 12. The right-hand and left-hand rear cargo doors of the vehicle are both equipped with upper and lower hinge brackets 12, 16 and upper and lower latch assemblies 14, 18.

In operation, when door 10 is opened to the 180 degree position shown in FIG. 1A, the outboard latch 36 of the upper latch assembly 14 is delatched from its striker pin 40 using actuator 44 and detent lever 42, thereby allowing fork bolt 38 to pivot clockwise and allowing door 10 to pivot downward and outboard as the upper latch assembly 14 travels laterally outboard with the slotted hole 32 moving relative to the upper striker pin 40. The door 10 is relatched when striker pin 40 forces fork bolt 48 of the upper latch assembly 14 to pivot counterclockwise into engagement with the striker pin and detent pin 52 to engage the fork bolt 48 at the inboard latch 34, as shown in FIG. 3. As this movement occurs, the door 10 pivots in the hole 32 of the lower latch assembly 18, as FIG. 1B shows.

Then the outboard latch 36 of the lower latch assembly 18 is delatched from its striker pin 40 using an actuator such as cable 44 and detent lever 42, thereby allowing the door 10 to be lifted upward or clockwise while being supported on the frame 22 by the upper and lower latch assemblies 14, 18. The door 10 is relatched when striker pin 40 forces fork bolt 48 of the lower latch assembly 18 to pivot counterclockwise into engagement with the striker pin at the inboard latch 34, shown in FIG. 3. As this movement occurs, the door 10 pivots in the hole 32 of the upper latch assembly 18, as FIG. 10 shows. The door 10 is then pivoted on its hinge pins 33 to the fully open position through an angle of about 180 degrees shown in FIG. 5.

The door 10 is closed by being pivoted on its hinges through an angle of about 180 degrees to the position shown in FIG. 10. Then the inboard latch 34 of the lower latch assembly 18 is delatched from its striker pin 40 using an actuator such as cable 54 and detent lever 52, thereby allowing the door 10 to pivot downward while being supported on the frame 22 by the upper and lower latch assemblies 14, 18. The door 10 is relatched when fork bolt 38 of the lower latch assembly 18 engages the striker pin 40 at the outboard latch 36. As this movement occurs, the door 10 pivots to the position shown in FIG. 1B.

The inboard latch 34 of the upper latch assembly 14 is then delatched from its striker pin 40 using actuator 54 and detent lever 52, thereby allowing door 10 to be lifted upward and inboard as the upper latch assembly 14 travels laterally inboard with the slotted hole 32 moving relative to the upper striker pin 40. The door 10 is relatched when fork bolt 38 of the upper latch assembly 14 engages the striker pin 40 at the outboard latch 36. As this movement occurs, the door 10 pivots to the position shown in FIG. 1A. Then the door is pivoted on its hinge pins 33 to the fully closed position.

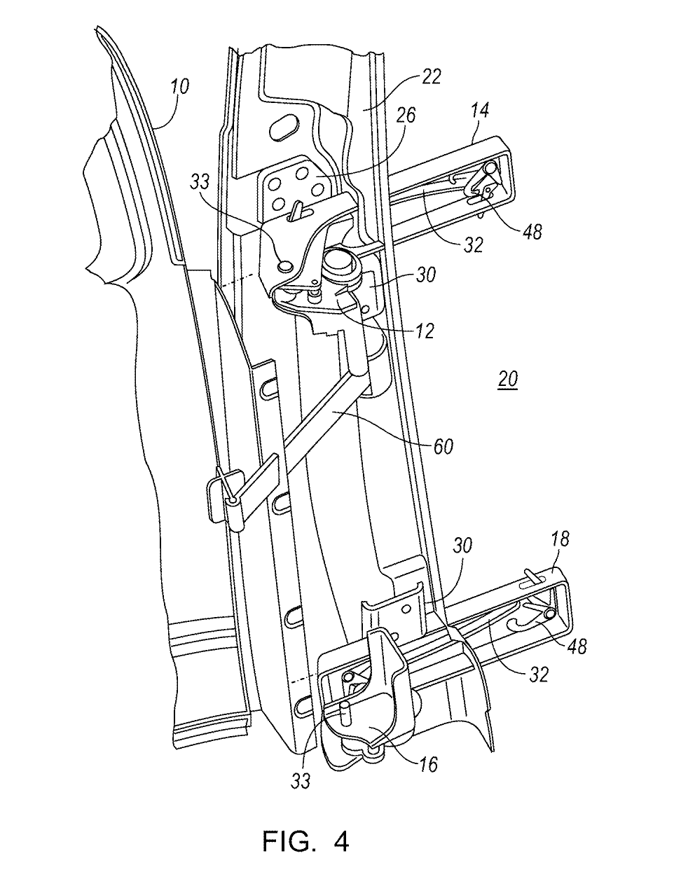

FIG. 4 shows a retractable, flexible stop strap 60 secured to the door 10 at one end and secured to a retractor at its inboard end, the retractor limiting the extent to which the strap 60 can extend. When either the upper or lower latch assembly 14, 18 is delatched, strap 60 extends to a first limit position (shown in FIG. 4) where the strap supports the door in the position shown in FIG. 1B. The strap 10 operates similar to a seat belt but has several length limits.

Before the door 10 moves to the position shown in FIG. 10, a limit pin that controls the strap retractor is actuated, thereby allowing strap 60 to extend further and door 10 to extend outboard to the position shown in FIG. 10 where the strap retractor limits movement of the door.

Then the limit pin is actuated again, allowing strap 60 to extend further such that the door 10 can be folded forward about the upper and lower hinge pins 33 to the fully open position shown in FIG. 5 where door 10 is substantially parallel to the side body panel 24. The stop strap retractor applies to the strap a force generally referred to as a check load.

As an alternative to the retractable stop strap 60, a two-position stop feature can be provided in the door hinge to position the door for both the intermediate and final stop positions. This alternative mechanism would also operate with the same inboard and outboard latches 34, 36, but would provide two stop positions to control the door movement.

While certain embodiments of the present invention have been described in detail, those familiar with the art to which this invention relates will recognize various alternative designs and embodiments for practicing the invention as defined by the following claims.

1-19. (canceled)

20. A mechanism for controlling a vehicle door, comprising:
a door frame surrounding a door opening;
an upper striker pin extending horizontally, secured to the door frame and fixed from movement relative to the door frame;
a lower striker pin extending horizontally, secured to the door frame below the upper striker pin and fixed from movement relative to the door frame;
an upper latch assembly including upper inboard and upper outboard latches, an upper slotted hole extending between the latches and into which the upper striker pin is fitted, a vertically extending upper hinge pin secured to the upper latch assembly, the upper striker pin configured to be slidable in the upper slotted hole between the upper inboard and upper outboard latches to allow the upper latch assembly and upper hinge pin to slide laterally relative to the door frame, the vehicle door mounted to the upper hinge pin and pivotable about the upper hinge pin; and
a lower latch assembly mounted below the upper latch assembly and including lower inboard and lower outboard latches, a lower slotted hole extending between the lower latches and into which the lower striker pin is fitted, a vertically extending lower hinge pin secured to the lower latch assembly, the lower striker pin configured to be slidable in the lower slotted hole between the lower inboard and lower outboard latches to allow the lower latch assembly and lower hinge pin to slide laterally relative to the door frame, the vehicle door mounted to the lower hinge pin and pivotable about the lower hinge pin.

21. The mechanism of claim 20 wherein the upper slotted hole is arcuate and the center of radius of the neutral line of the arcuate slot is higher at an outboard end of the upper slotted hole than at an inboard end of the upper slotted hole.

22. The mechanism of claim 21 wherein the lower slotted hole is arcuate and the center of radius of the neutral line of the arcuate slot is higher at an inboard end of the upper slotted hole than at an outboard end of the upper slotted hole.

23. The mechanism of claim 20 wherein the upper latch assembly includes an upper hinge bracket secured to and fixed relative to the upper latch assembly and the vehicle door, and the upper hinge pin is mounted on the upper hinge bracket, the upper hinge bracket and the upper hinge pin slidable laterally relative to the door frame when the upper striker pin slides in the upper slotted hole.

24. The mechanism of claim 23 wherein the lower latch assembly includes a lower hinge bracket secured to and fixed relative to the lower latch assembly and the vehicle door, and the lower hinge pin is mounted on the lower hinge bracket, the lower hinge bracket and the lower hinge pin slidable laterally relative to the door frame when the upper striker pin slides in the upper slotted hole.

25. The mechanism of claim 20 wherein the upper inboard latch includes an upper inboard fork bolt that is pivotally mounted to the upper latch assembly and configured to selectively retain the upper striker pin against an inboard end of the upper slotted hole, and the upper outboard latch includes an upper outboard fork bolt that is pivotally mounted to the upper latch assembly and configured to selectively retain the upper striker pin against an outboard end of the upper slotted hole.

26. The mechanism of claim 25 wherein the lower inboard latch includes a lower inboard fork bolt that is pivotally mounted to the lower latch assembly and configured to selectively retain the lower striker pin against an inboard end of the lower slotted hole, and the lower outboard latch includes a lower outboard fork bolt that is pivotally mounted to the lower latch assembly and configured to selectively retain the lower striker pin against an outboard end of the lower slotted hole.

27. The mechanism of claim 26 wherein the lower inboard latch includes an inboard detent lever configured to selectively engage the lower inboard fork bolt to selectively allow for and prohibit pivoting of the lower inboard fork bolt, whereby the lower inboard fork bolt selectively engages and releases the lower striker pin; and the lower outboard latch includes an outboard detent lever configured to selectively engage the lower outboard fork bolt to selectively allow for and prohibit pivoting of the lower outboard fork bolt, whereby the lower outboard fork bolt selectively engages and releases the lower striker pin.

28. The mechanism of claim 25 wherein the upper inboard latch includes an inboard detent lever configured to selectively engage the upper inboard fork bolt to selectively allow for and prohibit pivoting of the upper inboard fork bolt, whereby the upper inboard fork bolt selectively engages and releases the upper striker pin; and the upper outboard latch includes an outboard detent lever configured to selectively engage the upper outboard fork bolt to selectively allow for and prohibit pivoting of the upper outboard fork bolt, whereby the upper outboard fork bolt selectively engages and releases the upper striker pin.

29. The mechanism of claim 20 including a retractable flexible strap having a first end secured to the vehicle door and a second end secured to a retractor that is secured to the door frame, the retractor configured to selectively limit the length of the strap to selectively limit the movement of the vehicle door relative to the door frame.

30. The mechanism of claim 20 wherein the upper latch assembly is pivotable about upper striker pin relative to the door frame and the lower latch assembly is pivotable about the lower striker pin relative to the door frame, whereby releasing of the upper striker pin from the upper outboard latch assembly and retention of the lower striker pin in the lower outboard latch assembly causes the vehicle door adjacent to the upper latch assembly to slide outboard and pivot downward while the vehicle door adjacent to the lower latch assembly pivots downward without sliding outboard.
